(19) United States
(12) Patent Application Publication
(10) Pub. No.: US 2012/0006815 A1
(43) Pub. Date: Jan. 12, 2012

(54) VEHICLE TANK

(75) Inventors: Gernot Sendlhofer, Wagrain (AT); Christoph Lind, Gleisdorf (AT)

(73) Assignee: ALUTECH GESELLSCHAFT M.B.H., Lend (AT)

(21) Appl. No.: 13/257,432

(22) PCT Filed: Mar. 4, 2010
(86) PCT No.: PCT/AT2010/000062

§ 371 Date: Sep. 19, 2011

(30) Foreign Application Priority Data
Mar. 23, 2009 (AT) A 456/2009

(51) Int. Cl. B60K 15/03; F16K 31/18

(52) U.S. Cl. 220/4.14; 137/572; 137/428

(57) ABSTRACT

The invention relates to a vehicle tank for liquid fuels, including at least two compartments separated by a baffle, one compartment having a withdrawal line and the baffle having an opening which is close to the bottom and has a valve, and the valve opening independently of a pressure and/or fill level difference in the compartments when the fuel is on the side of the valve facing away from the withdrawal line.

The present invention relates to a vehicle tank for liquid operating fluids, with at least two compartments separated by a baffle, wherein one compartment provides a withdrawal line, and the baffle provides an opening disposed close to the bottom and fitted with a valve.

With known the vehicle tanks of this type, the valve is a non-return valve, which allows a flow into the compartment provided with the withdrawal line, but does not allow a flow outwards from it. Accordingly, when starting up, braking, travelling uphill or downhill, a fill-level in the withdrawal-line compartment sufficient for the withdrawal is always secured, even with a low fill-level of the tank. The non-return valve can also be used for filling only the withdrawal-line compartment for cost-saving in the case of the initial delivery of the vehicle (“first-fill”).

A non-return valve solution is known from WO 2008/105725 A1, wherein the valve integrated in the baffle opening comprises a non-return valve part and a floater valve part connected in series in front of the latter. The float element of the floater valve is disposed at the side of the baffle facing away from the withdrawal line. The floater valve part is used only to prevent the intake of air while the non-return valve part is open, thereby closing the floater valve. Accordingly, the valve is only open when the non-return valve has opened in a conventional manner and the floater valve has not yet fallen dry.

The known first-fill or uphill/downhill solutions provide the disadvantage that a correct fill-level measurement with a single fill-level sensor in the withdrawal-line chamber is not possible. However, the use of a single fill-level sensor would be very advantageous, because this can be integrated together with the withdrawal line in a single withdrawal module which can be included in the tank.

The object of the invention is to provide a vehicle tank with the named uphill/downhill and first-fill functionality, which allows an improved fill-level measurement. This object is achieved with a vehicle tank of the type named in the introduction, which is characterised according to the invention in that the valve opens independently from a pressure and/or fill-level difference of the compartments as soon as operating fluid is present at the side of the valve facing away from the withdrawal-line.

Accordingly, instead of a non-return valve, which responds to pressure and/or fill-level differences, a valve functionality is provided, which responds exclusively to the fill-level in the compartment in which no withdrawal line is disposed. On the one hand, all of the above-named uphill/downhill and first-fill functions can be achieved in a surprisingly simple manner; on the other hand, a free communication of the compartments and accordingly a correct fill-level display can be achieved in more operational cases than with the previously known solutions.

In a first preferred embodiment of the invention, the valve is controlled by a float element, which is disposed at the side of the baffle facing away from the withdrawal line. Accordingly, all types of known floater valve can be used for the vehicle tank according to the invention. By preference, in the closed position of the valve, the float element is disposed close to the baffle on the bottom of the chamber without the withdrawal line, thereby limiting the risk of an erroneous fill-level measurement to the case of a complete emptying of the compartment without the withdrawal line.

The named the float-controlled valve preferably provides a valve plate, which can be lifted from its valve seating by the float element via a lever drive. As an alternative, the float-controlled valves can provide an overflow channel with a closure element, which can be displaced in a sliding manner by the float element in order to release the overflow channel. Both variants allow a simple design not susceptible to failure.

A second preferred embodiment of the invention is characterised in that the valve is controlled by a pressure piston, which is provided on the side of the baffle facing away from the withdrawal line. With a corresponding dimension of the pressure piston, the valve can be opened whenever the operating fluid is disposed at the side of the valve facing away from the withdrawal line, and in fact, independently of the counter-pressure in the withdrawal-line chamber. This can be achieved, in particular, in that the pressure piston is a piston acting between the compartments, of which the piston surface facing away from the withdrawal line is substantially larger than its other piston surface.

A particularly simple design is obtained if the valve provides an overflow channel, which can be released by the pressure piston.

In every case, it is particularly favourable if, according to a further preferred feature of the invention, the valve is built into a sleeve, which can be inserted in a sealed manner into the named opening of the baffle, which simplifies the fitting of the vehicle tank.

By preference, the baffle can be provided in a per se known manner with further openings, which are disposed above the valve in order to allow the compartments to communicate freely with relatively higher fill-levels.

The invention is explained in greater detail below with reference to exemplary embodiments illustrated in the attached drawings. The drawings are as follows:

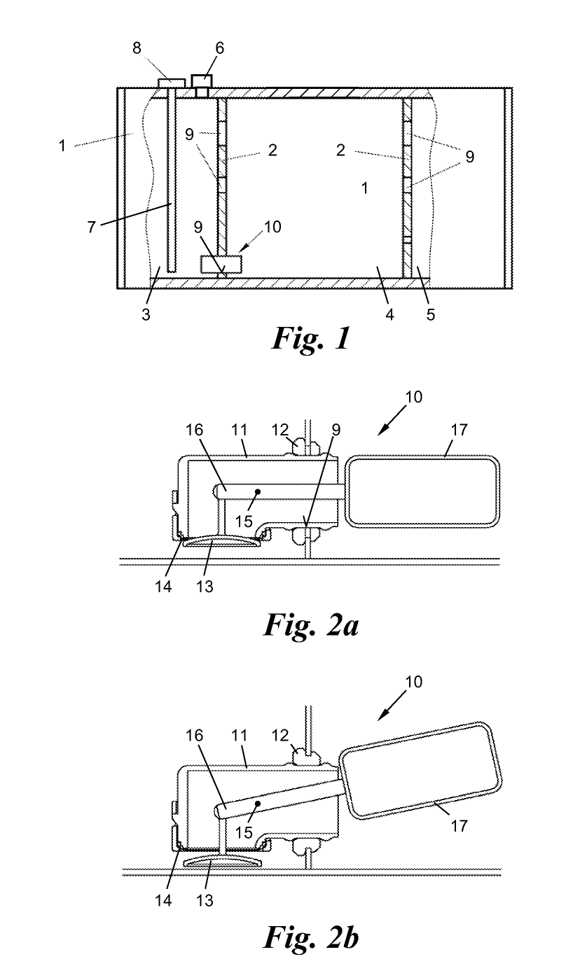

FIG. 1 shows a vehicle tank of the invention in cross-section;

FIGS. 2a and 2b show a first embodiment of the valve of the vehicle tank from FIG. 1 in cross-section in the closed and respectively opened condition;

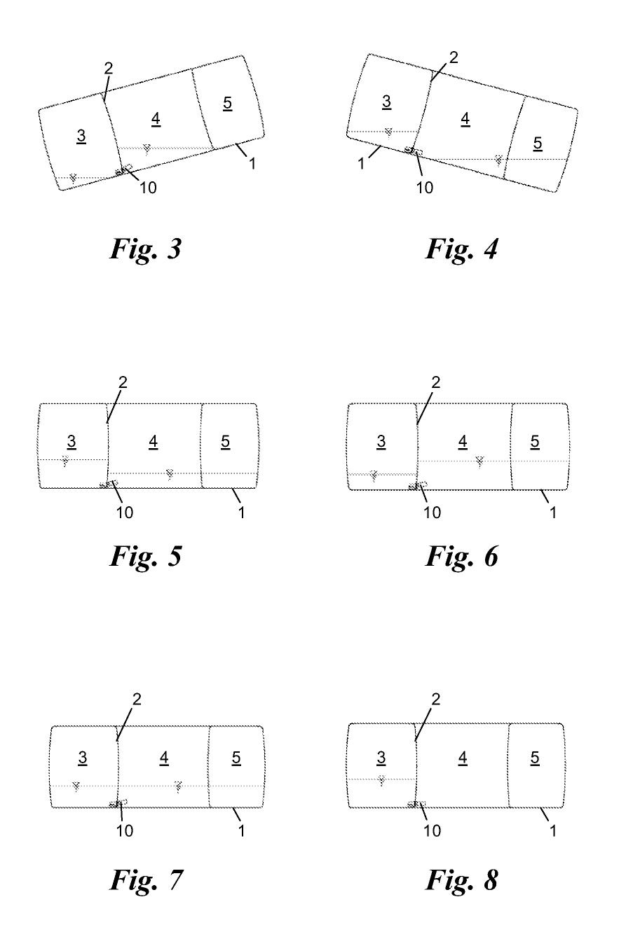

FIGS. 3 to 8 show the method of functioning of the vehicle tank with reference to various operating conditions; and

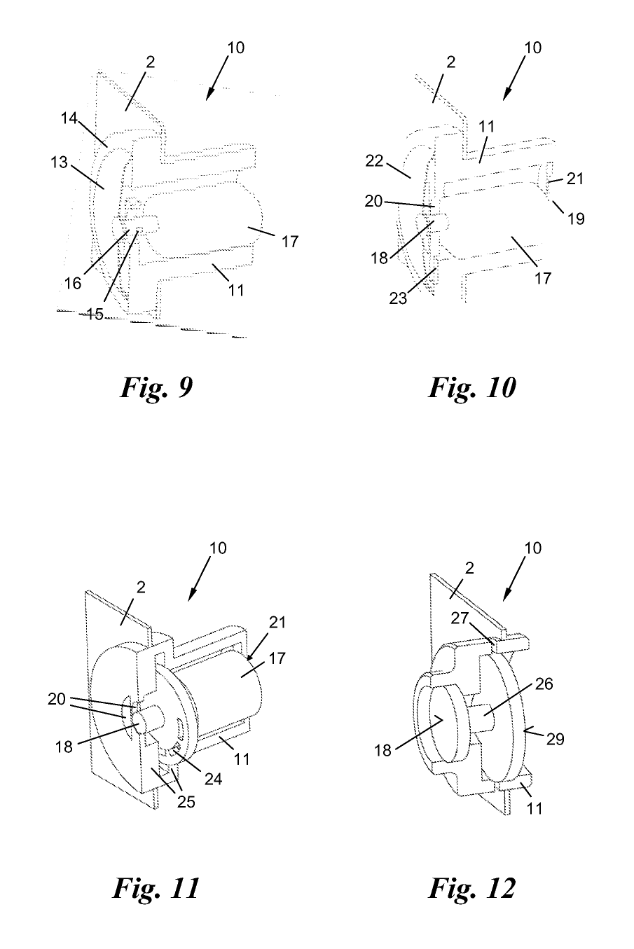

FIGS. 9 to 12 show various alternative embodiments of the valve, in each case in a partially sectional perspective view.

FIG. 1 shows a vehicle tank 1 for liquid operating fluids of a vehicle (not illustrated), for example, for fuel, hydraulic oil, catalytic fluid and so on. The vehicle tank 1 is subdivided by two baffles 2 into three compartments 3, 4 and 5, wherein the left-hand compartment 3 is provided with a filling pipe 6 and a withdrawal line 7. The withdrawal line 7 extends from the bottom of the first compartment 3 and is integrated, together with a fill-level sensor for the compartment 3 (not illustrated), in an approximately rod-shaped withdrawal module 8, which can be inserted into the tank 1 from above.

The baffles 2 are each provided in a conventional manner with openings 9. The opening 9 disposed closest to the bottom between the first compartment 3 and the second compartment 4 is fitted with a valve 10, of which the structure will be explained in greater detail with reference to FIGS. 2a and 2b, and of which the method of functioning will be explained in greater detail with reference to FIGS. 3 to 8.

The valve 10 is constructed within a sleeve 11, which can be fitted in a sealed manner in the opening 9 of the baffle 2 by means of a gasket 12. A valve plate 13 is mounted in the sleeve 11 in such a manner that it can be lifted from a valve seating 14. The valve plate 13 is controlled within the sleeve 11 by a float element 17 via a lever 16 articulated at 15, which projects into the second chamber 4. The float element 17 can be, for example, a hollow element or a synthetic-material element made of closed-pore foam.

The opening and closing of the valve 10 is accordingly independent of the pressure and/or fill-level difference between the compartments 3 and 4 and is dependent only on the presence of buoyancy-generating liquid operating fluid in the compartment 4, that is, dependent upon the fill-level of the compartment 4: when operating fluid is disposed at the side of the valve 10 facing away from the withdrawal line 7, the valve 10 opens, otherwise, it is closed.

The operating conditions and functions illustrated in FIGS. 3 to 8 can be realised in this manner. On the assumption that the vehicle tank 1 is integrated with the withdrawal-line compartment 3 facing towards the rear of the vehicle, FIG. 3 shows the diagonal position of the vehicle tank 1 in the case of an uphill travel. Because of the operating fluid disposed in the compartment 4, the float element 17 floats upwards and opens the valve 10, so that the operating fluid can flow into the compartment 3.

FIG. 4 shows the condition of downhill travel, in which, with a relatively low fill-level 4, the float element 17 of the valve 10 is dry and accordingly, the valve 10 closes in order to secure a still adequate fill-level in the compartment 3 for withdrawal via the withdrawal line 7.

FIGS. 5 and 6 each show the horizontal condition after uphill travel or downhill travel, in which the float element 17 floats upwards in the compartment 4 and opens the valve 10, so that the compartments 3 and 4 communicate with one another and balance their fill-levels, until a uniform fill-level is adopted in all three compartments 3, 4 and 5 of the vehicle tank 1 (FIG. 7). This means that, at the same time, the fill-level measured by the fill-level sensor in the compartment 3 corresponds to the total fill-level of the vehicle tank 1.

It should be particularly emphasised that the balancing movement, for example, from compartment 3 into compartment 4 shown in FIG. 5 is not possible with a conventional non-return valve, which is associated with the risk that an excessively high filled volume of the vehicle tank 1 is displayed in error.

FIG. 8 shows the only case in which the valve 10 closes in the horizontal condition of the vehicle tank 1. This situation is particularly rare, because it must have been preceded by a long uphill travel (FIG. 3), in which the second compartment 4 must have drained completely into the first compartment 3, which can also occur only in the case of a very small residual volume in the tank.

Conversely, FIG. 8 also shows the use of the valve 10 for the first-fill function in the case of the initial delivery of the vehicle. For reasons of cost-saving, exclusively the compartment 3 is filled for this purpose, and the valve 10 remains closed. In the case of the subsequent filling of the tank 1 via the filling pipe 6, the valve 10 is opened through the floating up of the float element 17 and therefore once again allows a communication between the compartments 3, 4 and 5 and a correct fill-level display.

FIGS. 9 to 12 show alternative variants of the valve 10. In the case of the embodiment of FIG. 9, the valve plate 13 is fitted directly to the lever 16 without deflection, and rises in tilting manner from its valve seating 14 when the float element 17 floats upwards. In this case, the valve plate 13 can be embodied, for example, as a large-area, elastic synthetic-material cap.

In FIG. 10, the float element 17 is mounted in the interior of the sleeve 11 in a linearly displaceable manner in the up and down direction, and in fact with the assistance of projections 18, 19 at the ends, which slide in guide slots 20, 21 of the sleeve 11. The projection 18 carries a sealing cap 22, which, in the lower position of the float element 17, covers an overflow channel 23 in the sleeve 11, and, in the upper position (not illustrated) releases it in order to open the valve 10.

FIG. 11 shows a further embodiment with a float element 17 capable of moving up and down, which is mounted in a linearly displaceable manner via the projections 18, 19 in guide slots 20, 21 of the sleeve 11. The float element 17 here is provided with overflow channels 24, which create a through connection via the slots 20, 21 and the interior of the sleeve 11 in the raised position of the float element 17; but which enter between and accordingly block the sealing plates 25 of the sleeve 11 in the dry, lower position of the float element 17.

FIG. 12 shows another embodiment of a valve 10, the opening of which is not controlled by a float element, but by a pressure piston 26, which is mounted in an axially displaceable manner in the sleeve 11. In its position displaced towards the right (as illustrated), the pressure piston 26 covers an overflow channel 27 in the wall of the sleeve 11, and, in its position displaced towards the left (not illustrated), it releases the former in order to open the valve.

As is evident from FIG. 12, the pressure piston 26 provides two significantly different piston surfaces, in fact, a small piston surface 28 facing towards the withdrawal line 7 and a large piston surface 29 facing away from the withdrawal line. The ratio of the piston surfaces 28 and 29 is selected in such a manner that even with a high fill-level in the compartment 3 (see, for example, FIG. 5), any operating fluid level—even only very shallow—in the compartment 4 is sufficient to move the piston 26 towards the left; only an empty or almost empty fill-level in the compartment 4 allows the piston 26 to move into its closed position shown in FIG. 12. Accordingly, all of the functionalities shown in FIGS. 3 to 8 can also be achieved.

The invention is not restricted to the illustrated embodiments, but comprises all variants and modifications which fall within the framework of the attached claims. Accordingly, the withdrawal line 7 can also be arranged, for example, between two baffles 2, in which case, both baffles are then provided with corresponding valves 10.

What is claimed is:

1. A vehicle tank for liquid operating fluid, with at least two compartments separated by a baffle, wherein one compartment provides a withdrawal line and the baffle provides an opening disposed close to the bottom and capable of being opened and closed by a valve, wherein the valve opens independently of a pressure and/or fill-level difference of the compartments as soon as operating fluid is present on the side of the valve facing away from the withdrawal line.

2. A vehicle tank according to claim 1, wherein the valve is controlled by a float element, which is disposed on the side of the baffle facing away from the withdrawal line.

3. A vehicle tank according to claim 2, wherein in the closed position of the valve, the float element rests close to the baffle at the bottom of the compartment without the withdrawal line.

4. The vehicle tank according to claim 2, wherein the valve provides a valve plate, which can be lifted from its valve seating by the float element via a lever drive.

5. The vehicle tank according to claim 2, wherein the valve provides an overflow channel with a closure element which can be displaced in a sliding manner by the float element in order to release the overflow channel.

6. The vehicle tank according to claim 1, wherein the valve is controlled by a pressure piston, which is provided on the side of the baffle facing away from the withdrawal line.

7. The vehicle tank according to claim 6, wherein the pressure piston is a piston acting between the compartments, of which the piston area facing away from the withdrawal line is substantially larger than its other piston surface.

8. The vehicle tank according to claim 6, wherein the valve provides an overflow channel, which can be released by the pressure piston.

9. The vehicle tank according to claim 1, wherein the valve is integrated in a sleeve, which can be inserted in a sealed manner into the opening.

10. The vehicle tank according to claim 1, wherein the baffle is provided in a per se known manner with further openings, which are disposed above the valve.
